(19) United States
(12) Patent Application Publication
(10) Pub. No.: US 2014/0360914 A1
(43) Pub. Date: Dec. 11, 2014

(54) WIPER BLADE PACKAGE

(71) Applicant: Wynalda Litho, Inc., Belmont, MI (US)

(72) Inventors: James Robert Denney, Walker, MI (US); Douglas Wynalda, Belmont, MI (US)

(73) Assignee: WYNALDA LITHO, INC., Belmont, MI (US)

(21) Appl. No.: 14/297,236

(22) Filed: Jun. 5, 2014

Related U.S. Application Data
(60) Provisional application No. 61/831,410, filed on Jun. 5, 2013.

(51) Int. Cl. B65D 81/05; B60S 1/38

(52) U.S. Cl. CPC B65D 81/058; B60S 1/3848; B65D 81/05; B60S 2001/3843
USPC 206/583; 206/586

(57) ABSTRACT

A packaging configuration for a wiper blade protects the wiper of the wiper blade from undesirable deformation while in the packaging. The packaging configuration includes a wiper holder that is placed on the wiper blade. The wiper holders are disposed at each end of the wiper blade to prevent at least the ends of the deformable wiper from resting against the inside of the storage and display container. The wiper holders can be end caps or rings. The wiper holders define a chamber that receives the wiper and allows it to rest in an unstressed condition. The different configurations can be used alone or in combination.

### CROSS REFERENCE TO RELATED APPLICATIONS

This application claims the benefit of U.S. Provisional Patent Application Ser. No. 61/831,410 filed Jun. 5, 2013; the disclosures of which are incorporated herein by reference.

### BACKGROUND OF THE DISCLOSURE

1. Technical Field

The disclosure generally relates to merchandise packaging and, more particularly to a packaging configuration for holding elongated wiper blades wherein the wiper of the wiper blade is protected from deformation while in the package.

2. Background Information

Almost all vehicles are equipped with one, two, or three (rear window wiper) powered wiper blade assemblies that include wiper blades carried at the ends of arms that are driven back and forth by a motor. Each wiper blade 2 includes a wiper base 4 that carries a wiper 6. Wiper base 4 provides strength, provides a connection point to the arm, and can provide a biasing force used to impart a desired curvature to wiper 6. Wiper 6 is the deformable rubber, elastomeric, plastic, or other deformable member that contacts and cleans the glass of the vehicle.

The wipers or wiper blades are removable and replaceable because the wiper wears from use and exposure. Replacement wiper blades that meet a wide variety of vehicle specifications are thus distributed throughout the world in a wide variety of wiper blade packaging. A common package is an elongated box or sleeve that contains the wiper blade. An example of a prior art polymer sleeve 10 is depicted in FIGS. 1 and 2. These sleeves 10 may be used alone or in combination with outer boxes. These sleeves may be stacked horizontally or vertically for storage and shipping and may be displayed in horizontal stacks or hung vertically from a hook. In many situations, a simple sleeve will allow at least the end portions wiper 6 to contact the sleeve 10. In some configurations, a substantial portion of the length of wiper 6 is in contact with sleeve 10. This contact causes wiper 6 to deform over time as shown in FIG. 2 wherein wiper 6 is bent and tilted off to the right side of wiper base 4. A deformed wiper 6 degrades the performance of wiper blade 2 when it is installed on a vehicle. In recognition of this problem, some packages have been proposed that interact with wiper base 4 to isolate the wiper within the package. U.S. Pat. No. 7,975,849 discloses one clamshell-style solution where in the primary packaging body interacts with the wiper base to position the wiper in a desirable position.

### SUMMARY OF THE DISCLOSURE

The disclosure provides a packaging configuration for a wiper blade wherein the wiper is protected against undesirable deformation while in the packaging.

The disclosure provides a packaging configuration wherein a wiper holder in the form of an end cap or a ring. Wiper holders are disposed along the wiper blade to prevent or limit the wiper from contacting the packaging and becoming deformed during shipping, storage, and display. One configuration of the wiper holder is provided as an end cap that includes an end wall. This configuration is used on the two ends of the wiper blade to protect the ends from contact with the packaging. Another configuration of the wiper holder is a ring that does not have the end wall so that the wiper blade may pass through the wiper holder so that a plurality of wiper holders can be disposed along the length of the wiper blade. The different configurations can be used alone or in combination.

In one exemplary configuration, each wiper holder includes a body having a perimeter sidewall that defines an open chamber. The perimeter sidewall includes a pair of opposed ledges that partially divide the chamber into first and second portions. The end of a wiper blade slides into the chamber with the wiper base disposed against the ledges in the first portion of the chamber and the wiper extending between the ledges into the second portion of the chamber. The second portion of the chamber is sized to be larger than the wiper such that the wiper hangs freely within the second portion of the chamber or is sized such that the tip of the wiper frictionally engages the inner surface of the sidewall. The sidewall of the wiper holder thus protects the wiper from direct contact with the interior of the primary packaging at least at the location of the wiper holder.

In one configuration, the inner surface of the portion of the sidewall that defines the first chamber of the wiper holder defines three corners to receive the end of a wiper blade in a friction fit. Another configuration of the wiper holder has a non-continuous sidewall that defines an open-ended first chamber portion that allows a portion of the wiper base to extend out of the wiper holder. A further configuration has a first chamber portion having an irregular cross section configuration to match the wiper blade on which the holder is to be used.

The configuration of the outer surface of the wiper holder provides a predictable position for the wiper blade within the packaging sleeve. The outer configuration may be tear-drop, diamond, shield, or rounded with at least a single point that functions to orient the wiper holder with respect to the packaging sleeve.

The disclosure provides a packaging sleeve having a cross section that cooperates with the wiper holder to position the wiper blade in a predictable configuration that prevents the deformation of the wiper while it is stored and displayed within the packaging sleeve.

The wiper holders can be positioned on either end of the wiper blade.

The wiper holders can be positioned onto different wiper blade configurations.

The wiper holder chambers have different configurations so that different wiper blades may position the wiper base in the second chamber while the wiper will extend into the first chamber.

The wiper holders may be made from polymer, metal, fiber-based material, paper-based material, and the like.

The wiper holders can be brightly colored to make it easy for a person to remember to remove them during installation of the wiper blade.

### BRIEF DESCRIPTION OF THE DRAWINGS

FIG. 1 is side view of a wiper blade disposed in a prior art packaging sleeve.

FIG. 2 is a section view taken along line 2-2 of FIG. 1 showing how the end of the wiper can become deformed.

FIG. 3 is a rear perspective view of a first exemplary configuration for a wiper holder showing the configuration of the chambers.

FIG. 4 is a perspective view showing the installation of the first configuration of the wiper holder being positioned on the end of the wiper blade.

FIG. 5 is a perspective view showing the first configuration of the wiper holder installed on the end of a wiper blade.

FIG. 6 is another perspective view showing the first configuration of the wiper holder installed on the end of a wiper blade.

FIG. 7 is a front view of a wiper blade with two wiper holders installed.

FIG. 8 is an end view of the first configuration of the wiper holder showing an exemplary wiper blade in cross section.

FIG. 9 is a perspective view of the first exemplary wiper holder configuration.

FIG. 10 is a perspective view of a second exemplary configuration for the wiper holder.

FIG. 11 is an end view of the second configuration of the wiper holder showing an exemplary wiper blade in cross section.

FIG. 12 is a perspective view of a third exemplary configuration for the wiper holder.

FIG. 13 is an end view of the third configuration of the wiper holder showing an exemplary wiper blade in cross section.

FIG. 14 is a perspective view of a fourth exemplary configuration for the wiper holder.

FIG. 15 is an end view of the fourth configuration of the wiper holder showing an exemplary wiper blade in cross section.

FIG. 16 is a perspective view of a fifth exemplary configuration for the wiper holder.

FIG. 17 is an end view of the fifth configuration of the wiper holder showing an exemplary wiper blade in cross section.

FIG. 18 is a perspective view of a sixth exemplary configuration for the wiper holder.

FIG. 19 is an end view of the sixth configuration of the wiper holder showing an exemplary wiper blade in cross section.

FIG. 20 is side view of a wiper blade with a pair of wiper holders disposed in a packaging sleeve.

FIG. 21 is a section view of a packing sleeve with a wiper blade and wiper holder taken along line 21-21 of FIG. 20.

Similar numbers refer to similar parts throughout the specification.

### DETAILED DESCRIPTION OF THE DISCLOSURE

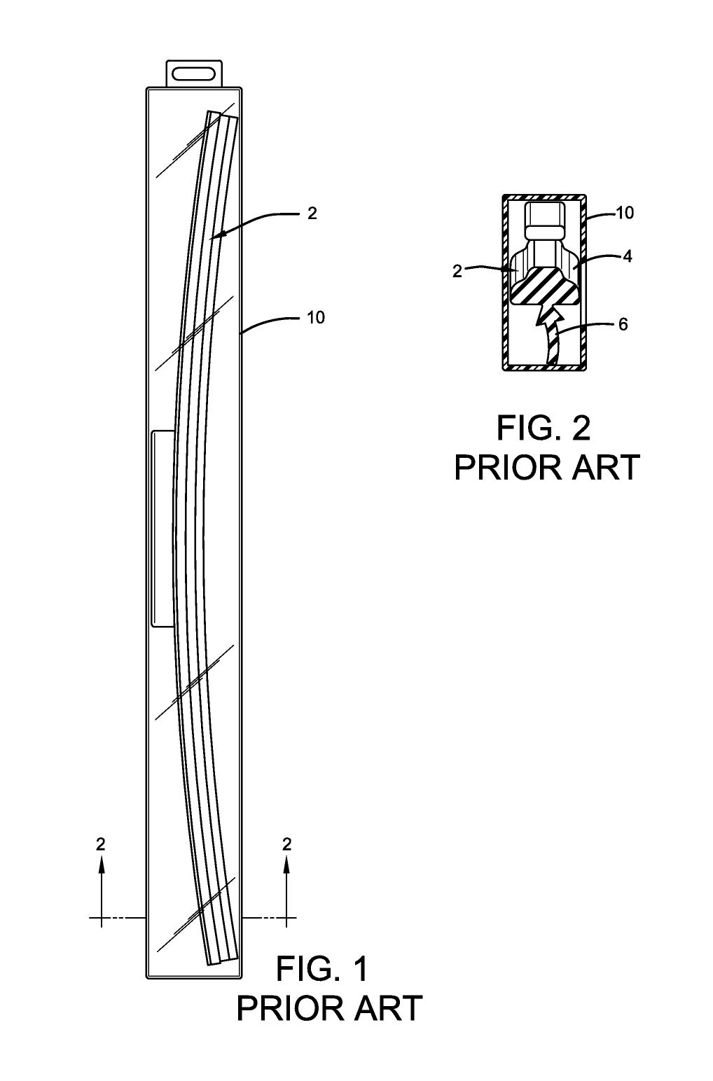

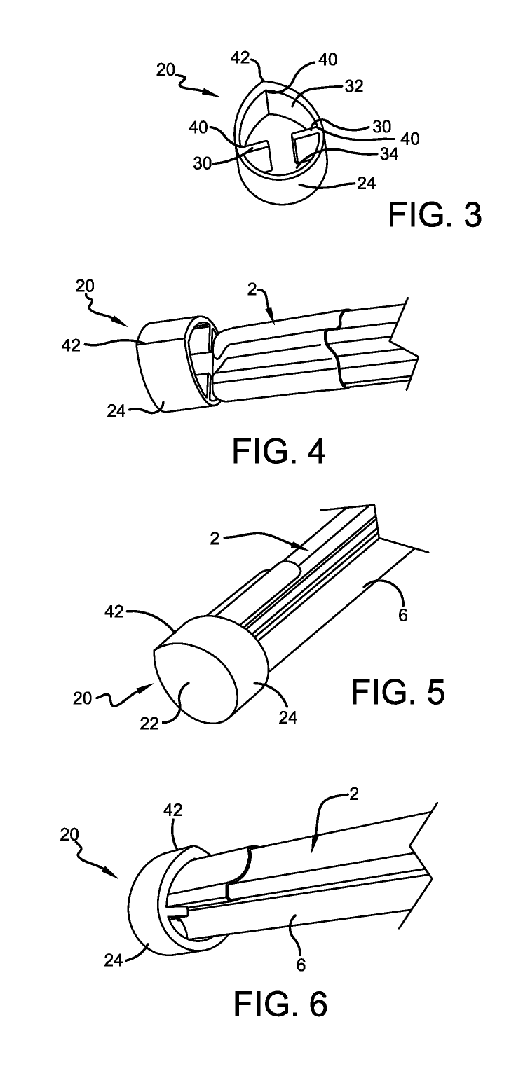

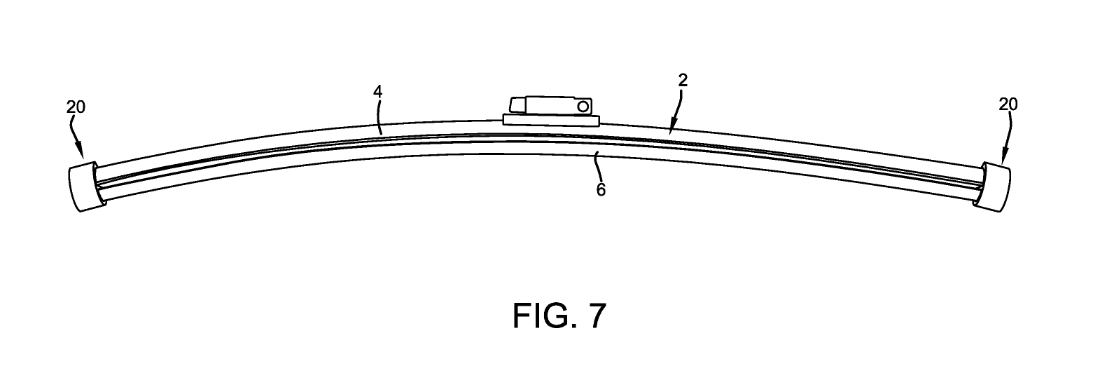

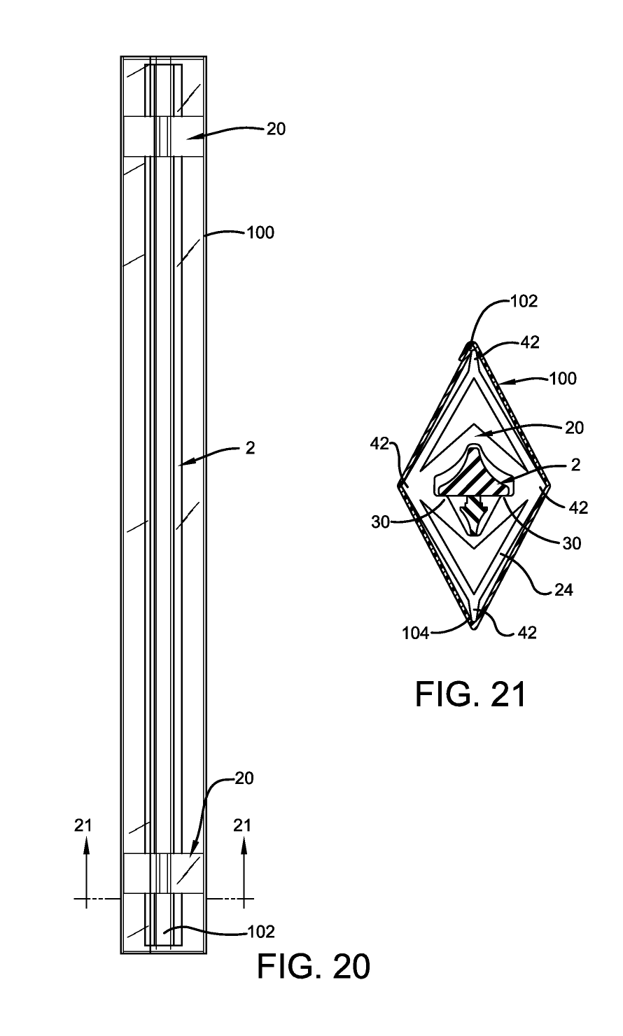

The exemplary configurations of the wiper holders used to protect at least the ends of the wiper 6 of a wiper blade 2 are indicated generally by the reference numeral 20 in the accompanying drawings. Wiper holders 20 are disposed over portions of wiper blade 2 to protect at least those portions of wiper 6 from deformation when wiper blade 2 is disposed in a storage and display container (such as box 10). The storage and display container can be any of a wide variety of containers such as the rectangular box depicted in FIGS. 1 and 2. The container also may be a sleeve 100 or a tube 100 (FIG. 20) that receives wiper blade 2. As described below, some configurations of the storage and display container 100 have features that cooperate with wiper holders 20 to position wiper blade 2 in a predictable configuration with respect to container 100. Wiper holders 20 can be loosely disposed on wiper blade 2 such that they may slide along the length of wiper blade 2. Wiper holders 20 can frictionally engage wiper blade 2 so their positions do not readily change. Each wiper holder 20 supports wiper base 4 while provide space for wiper 6 wherein it is received in its natural unstressed position. Each wiper holder 20 provides a protective sidewall 24 that prevents the portion of the wiper 6 disposed within wiper holder 20 from engaging the interior of the exterior container.

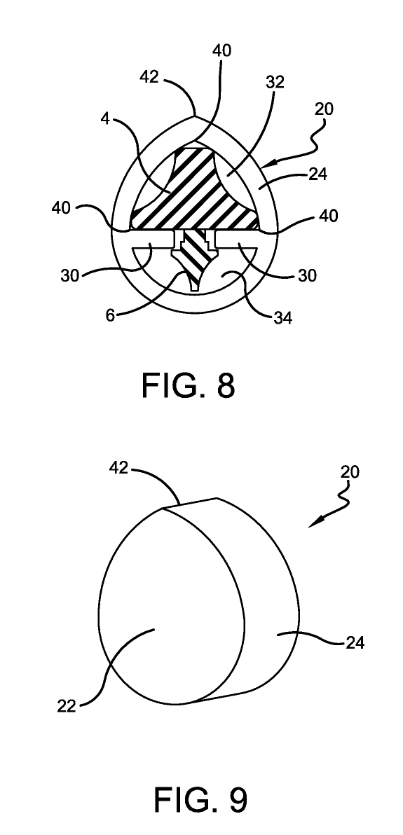

In a first exemplary configuration, each wiper holder 20 includes a body defined by an end wall 22 and a perimeter sidewall 24 that cooperate to define an open chamber. Sidewall 24 includes a pair of opposed ledges 30 that extend into the chamber to partially divide the chamber into a first chamber portion 32 and a second chamber portion 34. These chamber portions are sized to work with a single wiper blade size and configuration or a range of wiper blade sizes and configurations. The end of wiper base 4 of a wiper blade 2 is frictionally received in first chamber portion 32 with wiper base 4 being disposed against ledges 30 such that wiper 6 extends between the spaced ends of ledges 30 into second chamber portion 34. This arrangement is shown in FIG. 8. Second chamber portion 34 is sized to be larger than wiper 6 such that wiper 6 hangs freely in an unstressed condition within second chamber portion 34. In the first configuration, end wall 22 prevents wiper blade 2 from extending entirely through wiper holder 20 such that wiper holder 20 is fit onto the ends of wiper blade 2. Wiper holder 20 thus protects the end of wiper 6 from direct contact with the interior of the storage and display container. Some wiper blades 2 have wiper 6 with a notch between a flange and wiper base 4. The inner ends of ledges 30 can be disposed in this notch to hold the position of wiper 6 with respect to wiper base 4. FIGS. 8 and 15 depict this configuration.

In the first exemplary configuration, sidewall 24 and ledges 30 define three interior corners 40 for first chamber portion 32. These corners 40 are configured to frictionally receive the three corners of wiper base 4. The interior surface of sidewall 24 is bowed outwardly from corner 40 to corner 40 to provide space to receive the end of wiper blade 2. In this example, second chamber portion 34 is partially defined by a semi-circular section of the inner surface of sidewall 24.

End wall 22 and sidewall 24 of the first configuration of wiper holder 20 can be generally teardrop shaped or rounded with a single or multiple tips 42 so that it will fit inside the storage and display container 100 in a predictable configuration. When wiper holder 20 is provided with one or more tips 42, the alignment of wiper holder 20 with container 100 can be coordinated to place wiper blade 2 in a predictable configuration within the packaging. The single tip 42 or multiple tips 42 limit the rotation of wiper holder 20 with container 100.

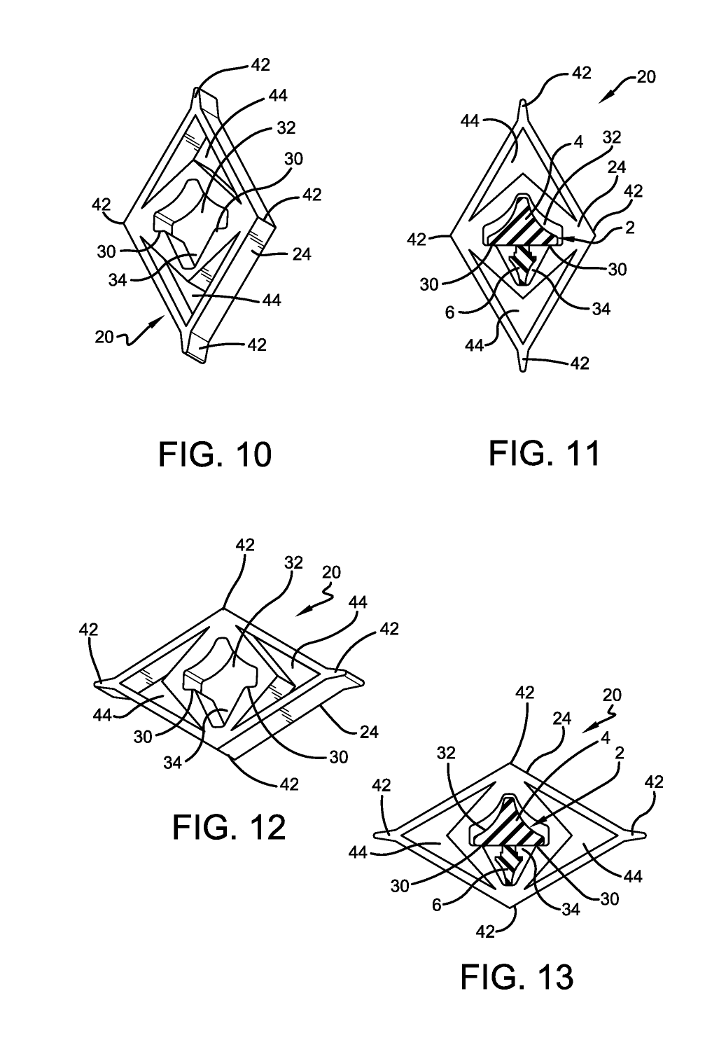

The second exemplary configuration of wiper holder 20 is depicted in FIGS. 10 and 11. In the second exemplary configuration, wiper holder 20 includes a body primarily defined by perimeter sidewall 24 that defines a chamber that extends entirely through the body. This configuration allows wiper holder 20 to be slid along the length of wiper blade 2. Sidewall 24 includes a pair of opposed ledges 30 that extend into the chamber to partially divide the chamber into a first chamber portion 32 and a second chamber portion 34. Wiper base 4 of a wiper blade 2 frictionally slides into the first chamber portion 32 with the wiper base 4 being disposed against ledges 30 with wiper 6 extending between the spaced ends of ledges 30 into second chamber portion 34. Second chamber portion 34 can be sized to be larger than wiper 6 such that wiper 6 hangs freely in an unstressed condition within second chamber portion 34. In the FIG. 11 configuration, second chamber portion is sized to allow the end of wiper 6 to lightly engage the inner surface of sidewall 24 to hold wiper 6 in position. This engagement limits movement of wiper 6 but does not stress wiper 6.

Sidewall 24 of the second configuration of wiper holder 20 can be generally diamond-shaped with a plurality of tips 42 so that it will fit inside the storage and display container 100 in a predictable configuration. The tips 42 of wiper holder 20 are used to retain the alignment of wiper holder 20 within container 100 so the wiper blade 2 is held in a predictable configuration. Tips 42 prevent any rotation of wiper holder 20 with the container 100. In this configuration, sidewall 24 defines openings 44 to reduce the amount of material used to form holder 20. These openings 44 define inner and outer sidewall portions with the inner sidewall portions defining the chamber of wiper holder 20.

The third exemplary configuration of wiper holder 20 is depicted in FIGS. 12 and 13. The third configuration is substantially the same as the second configuration except the chamber defined by sidewall 24 is turned ninety degrees.

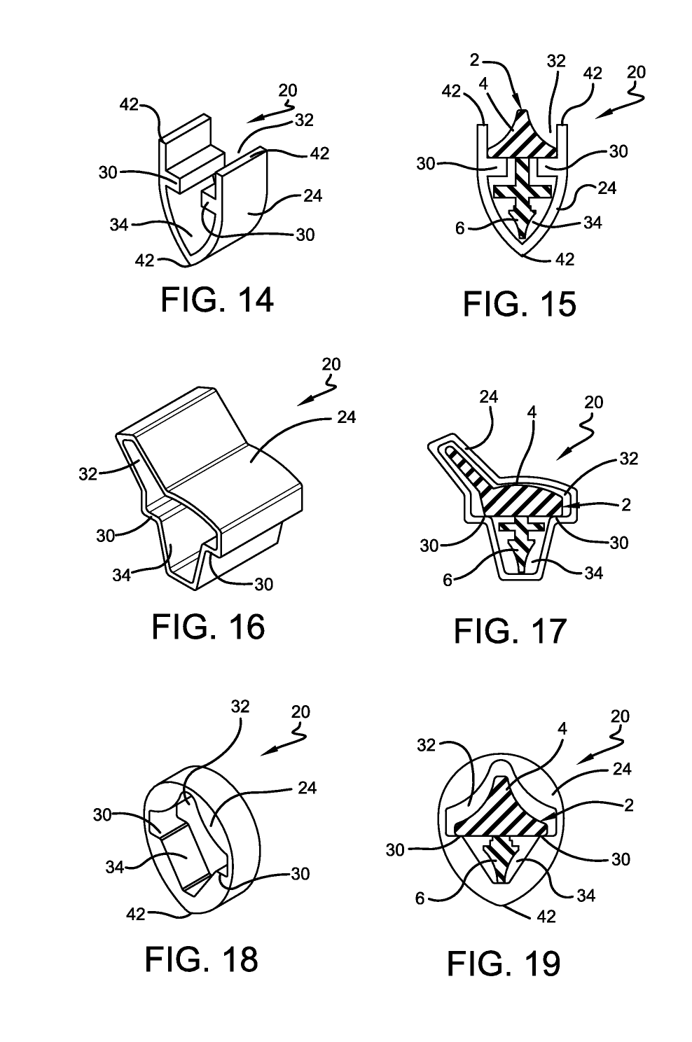

The fourth exemplary configuration of wiper holder 20 is depicted in FIGS. 14 and 15. In the second exemplary configuration, wiper holder 20 includes a body primarily defined by perimeter sidewall 24 that defines a chamber that extends through the body. This configuration allows wiper holder 20 to be slid along the length of wiper blade 2. The fourth configuration also defines a chamber that is open through a portion of sidewall 24 such that a portion of wiper blade 2 can extend out of the chamber.

The fourth configuration also has a pair of opposed ledges 30 that extend into the chamber to partially divide the chamber into a first chamber portion 32 and a second chamber portion 34. These ledges 30 have inner ends that fit between wiper base 4 and a flange of wiper 6. Ledges 30 thus help retain wiper holder 20 on wiper blade 2. Wiper base 4 of a wiper blade 2 can frictionally engage the inner portion of sidewall 24 that defines first chamber portion 32. The frictional engagement can help maintain the connection between wiper blade 2 and wiper holder 20. Second chamber portion 34 can be sized to be larger than wiper 6 such that wiper 6 hangs freely in an unstressed condition within second chamber portion 34. As noted above, first chamber portion 32 is open through sidewall 24 such that sidewall 24 is noncontinuous. This allows a portion of wiper base 4 to extend out of wiper holder 20.

Sidewall 24 of the fourth configuration of wiper holder 20 can be generally shield-shaped with a plurality of tips 42 so that it will fit inside the storage and display container in a predictable configuration. The tips 42 of wiper holder 20 are used to retain the alignment of wiper holder 20 with the packaging so the wiper blade 2 is held in a predictable configuration within the packaging.

The fifth exemplary configuration of wiper holder 20 is depicted in FIGS. 16 and 17. The fifth configuration also has sidewall 24 and ledges 30 that define first chamber portion 32 and second chamber portion 34. In this configuration, first chamber portion 32 has an extension adapted to receive a flange that extends from wiper blade 2. By shaping wiper holder 20 with extensions in this manner, wiper holder 20 can be adapted to fit a wide variety of wiper blades 2.

The sixth exemplary configuration of wiper holder 20 is depicted in FIGS. 18 and 19. In the sixth exemplary configuration, wiper holder 20 includes a body defined by perimeter sidewall 24 that defines a chamber that extends through the body. This configuration allows wiper holder 20 to be slid along the length of wiper blade 2. Sidewall 24 includes a pair of opposed ledges 30 that partially divide the chamber into a first chamber portion 32 and a second chamber portion 34. Wiper base 4 of a wiper blade 2 frictionally slides into the first chamber portion 32 with the wiper base 4 being disposed against ledges 30 with wiper 6 extending between the spaced ends of ledges 30 into second chamber portion 34. Second chamber portion 34 can be sized to be larger than wiper 6 such that wiper 6 hangs freely in an unstressed condition within second chamber portion 34. In the FIG. 19 configuration, second chamber portion is sized to allow the end of wiper 6 to engage the inner surface of sidewall 24 to hold wiper 6 in position. This configuration also has a second chamber portion 34 with converging inner walls that minimize movement of wiper 6 and function to center wiper 6 as it moves into second chamber portion 34.

The outer surface of sidewall 24 can be textured or knurled to provide a gripping surface for easy removal. Wiper holders 20 may be fabricated from a moldable or extrudable polymer and may be made from PVC, polypropylene, polyethylene, polycarbonate, and other similar materials. Wiper holders 20 can be made from a metal, a wood, or a paper-based material. The configurations of wiper holders 20 having through-chambers can be extruded and cut to length. Wiper holders 20 may be made from a recycled material.

Wiper holders 20 may be brightly colored compared to the typical dark color of wiper blades 2 so that the installer's attention will be drawn to wiper holders 20 and they will be removed prior to the installation of wiper blades 2. Wiper holders 20 may be blue, yellow, orange, green, or red.

FIGS. 20 and 21 depicts an exemplary packaging sleeve 100 that may be used with wiper holder 20. In cross section, sleeve 100 has an upper peak 102 and a lower peak 104 that may receive tips 42 of wiper holder 20 to limit the movement of wiper holder 20 within sleeve 100.

In the foregoing description, certain terms have been used for brevity, clearness, and understanding. No unnecessary limitations are to be implied therefrom beyond the requirement of the prior art because such terms are used for descriptive purposes and are intended to be broadly construed. Moreover, the description and illustration of the invention is an example and the invention is not limited to the exact details shown or described. Throughout the description and claims of this specification the words “comprise” and “include” as well as variations of those words, such as “comprises,” “includes,” “comprising,” and “including” are not intended to exclude additives, components, integers, or steps.

1. A wiper blade package comprising:
a wiper blade having a wiper base and a wiper;
a wiper holder disposed on the wiper blade; the wiper holder having a sidewall that defines a chamber;
the wiper disposed in the chamber of the wiper holder;
a container; and
the wiper blade and wiper holder being disposed in the container; the wiper holder preventing the portion of the wiper disposed in the chamber from contacting the container.

2. The wiper blade package of claim 1, further comprising a plurality of wiper holders disposed on the wiper blade.

3. The wiper blade package of claim 1, wherein the wiper holder includes at least one tip that projects outwardly away from the wiper blade; the tip adapted to limit rotation of the wiper holder within the container.

4. The wiper blade package of claim 3 wherein the wiper holder includes a plurality of outwardly projecting tips.

5. The wiper blade package of claim 4, wherein two of the tips project away from each other is opposite directions.

6. The wiper blade package of claim 1, wherein the sidewall of the wiper holder includes opposed ledges that divide the chamber of the wiper holder into first and second chamber portions; a portion of the wiper base disposed in the first chamber portion and engaging the ledges; and the wiper extending between the ledges into the second chamber portion.

7. The wiper blade package of claim 6, wherein the wiper includes a flange and a neck that connects the flange to the wiper base and wherein the ledges have inner ends disposed between the wiper base and the flange of the wiper.

8. The wiper blade package of claim 6, wherein the sidewall defines three corners in the first chamber portion.

9. The wiper blade package of claim 6, wherein the wiper holder includes an end wall that closes the chamber.

10. The wiper blade package of claim 6, wherein the sidewall is noncontinuous and the first chamber portion is open through the sidewall.

11. The wiper blade package of claim 10, wherein the wiper base extends out of the first chamber portion.

12. A wiper holder for use on a wiper blade to protect a portion of the wiper from undesirable deformation; the wiper holder comprising:
a body having a sidewall that defines a chamber; and
the sidewall including opposed ledges that divide the chamber into first and second chamber portions; a portion of the wiper adapted to be disposed in the first chamber portion and engaging the ledges; and a portion of the wiper adapted to extend between the ledges into the second chamber portion.

13. The wiper holder of claim 12, wherein the wiper holder includes at least one tip that projects outwardly away from the wiper blade; the tip adapted to limit rotation of the wiper holder within the container.

14. The wiper holder of claim 13 wherein the wiper holder includes a plurality of outwardly projecting tips.

15. The wiper holder of claim 14, wherein two of the tips project away from each other is opposite directions.

16. The wiper holder of claim 12, wherein the sidewall defines three corners in the first chamber portion.

17. The wiper holder of claim 12, wherein the wiper holder includes an end wall that closes the chamber.

18. The wiper holder of claim 12, wherein the sidewall is noncontinuous and the first chamber portion is open through the sidewall.
